(19) United States
(12) Patent Application Publication
(10) Pub. No.: US 2008/0294555 A1
(43) Pub. Date: Nov. 27, 2008

(54) Data network-implemented tax advantaged account transaction and reconciliation

(75) Inventor: Hubert F-J Bromma, Reno, NV (US)

Correspondence Address: KOKKA & BACKUS, PC, 200 PAGE MILL ROAD, SUITE 103, PALO ALTO, CA, 94306, US

(73) Assignee: Hubert F-J Bromma, Reno, NV (US)

(21) Appl. No.: 11/805,179

(22) Filed: May 21, 2007

(51) Int. Cl. G06Q 40/00

(52) U.S. Cl. 705/43

(57) ABSTRACT

Data network-implemented tax advantaged account transaction and reconciliation is described, including identifying a tax advantaged account, the tax advantaged account being identified using a card configured to store data, receiving a transaction request, the transaction request being associated with the tax advantaged account, determining whether the transaction request indicates a taxable event, performing a transaction associated with the transaction request and the tax advantaged account, and generating a report associated with the tax advantaged account, the report indicating that a transaction was performed based on the transaction request.

### FIELD OF THE INVENTION

The present invention relates generally to computer programs, software applications, and financial services. More specifically, data network-implemented tax advantaged account transaction and reconciliation is described.

### BACKGROUND OF THE INVENTION

Tax advantaged accounts exist to allow investors to set aside funds for retirement, educational, health and medical, and other costs while deferring or avoiding tax treatment (i.e., tax payments). Some conventional tax advantaged accounts are used as individual retirement accounts (“retirement accounts”) to set aside pre-tax income for use upon reaching retirement age, typically at age 59½ years or older. However, conventional techniques for making distributions from or contributions to tax advantaged accounts are slow, time-consuming, and regulation-intensive, which can be burdensome upon tax payers seeking to gain access to funds for various uses before, during, or after an individual's reaches an appropriate retirement age.

Conventionally, when withdrawals or distributions (“distributions”) or deposits or contributions (“contributions”) involve tax advantaged accounts various types of reporting and regulatory requirements must be fulfilled. For example, disclosure reports are generated and sent by the account owner and a custodian or Trustee (“Trustee”) of the account, to ensure that transactions receive tax treatment in accordance with current tax laws, such as the Internal Revenue Code (IRC). Further, transactions (e.g., distributions, contributions) may be labor and time-consuming, manual, and regulation-intensive, requiring specialized knowledge, certification, and licensing of Trustees to oversee and manage the retirement accounts and funds. Subsequently, conventional techniques for performing transactions related to tax advantaged accounts are typically slow and incur significant delays for consumers. Trustees may be institutions, such as banks, financial services, and insurance companies for individual retirement arrangements (i.e., accounts) as well as individuals for qualified plans. Trustees or provide oversight, management, and regulatory compliance services for the tax payers (i.e., consumers) who own tax advantaged accounts. Often, Trustee services are often difficult to use, slow, and complicated, which can deter, prevent, or confuse tax payers seeking to use their tax advantaged accounts for educational, health, medical, or other permitted uses.

Some conventional techniques for taking a distribution from or making a contribution to a tax advantaged account require time and labor-intensive activities such as determining the age of the tax payer, whether a distribution is premature (i.e., the requesting tax payer is younger than a statutorily-defined age after which tax penalties do not apply) or normal (i.e., the requesting tax payer is older than a statutorily-defined age after which tax penalties do not apply)), whether a requested amount meets, exceeds, or falls below a required minimum distribution (RMD) amount, authentication and authorization for a transaction. When determining whether funds are available (i.e., in the case of a request for a distribution), if the funds are not available in cash or short-term liquid assets, Trustees must determine whether the funds can be made available, and, in the case of a contribution, whether an annual limit on contributions to a tax advantaged account has been met or surpassed. Other determinations for regulatory and statutory compliance exist, which further complicates the process for enabling consumers to effectively use and manage their tax advantaged accounts.

Thus, a solution for using tax advantaged accounts without the limitations of conventional techniques is needed.

### BRIEF DESCRIPTION OF THE DRAWINGS

Various examples are disclosed in the following detailed description and the accompanying drawings:

FIG. 1 illustrates an exemplary tax advantaged account distribution and reconciliation data network;

FIG. 2A illustrates an exemplary tax advantaged account transaction and reconciliation system;

FIG. 2B illustrates an alternative exemplary tax advantaged account transaction and reconciliation system;

FIG. 2C illustrates another alternative exemplary tax advantaged account transaction and reconciliation system;

FIG. 2D illustrates a further exemplary tax advantaged account transaction and reconciliation system;

FIG. 2E illustrates yet another alternative exemplary tax advantaged account transaction and reconciliation system;

FIG. 3 illustrates an exemplary tax advantaged account transaction and reconciliation application architecture;

FIG. 4A illustrates an exemplary tax advantaged account transaction and reconciliation process;

FIG. 4B illustrates an exemplary tax advantaged account transaction and reconciliation sub-process;

FIG. 4C illustrates another exemplary tax advantaged account transaction and reconciliation sub-process;

FIG. 5 illustrates an alternative exemplary tax advantaged account transaction and reconciliation process; and

FIG. 6 illustrates an exemplary computer system suitable for tax advantaged account transaction and reconciliation.

### DETAILED DESCRIPTION

Various embodiments or examples may be implemented in numerous ways, including as a system, a process, an apparatus, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided as examples and the described techniques may be practiced according to the claims without some or all of the accompanying details. For clarity, technical material that is known in the technical fields related to the embodiments has not been described in detail to avoid unnecessarily obscuring the description.

In some examples, the described techniques may be implemented as a computer program or application (“application”) or as a module or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including C, Objective C, C++, C#, Flex™, Java™, Javascript™, Ajax, COBOL, Fortran, ADA, XML, HTML, DHTML, XHTML, HTTP, XMPP, and others. Design, publishing, and other types of applications such as Dreamweaver®, Shockwave®, Flash®, and Fireworks® may also be used to implement the described techniques. The described techniques may be varied and are not limited to the examples or descriptions provided.

Data network-implemented retirement account distribution and reconciliation is described. In some examples, a card having stored or embedded circuitry, hardware, software, memory, or other facilities for identifying one or more tax advantaged accounts (e.g., magnetic strip card, smart card, subscriber identity module (SIM) card, cards read using optical character recognition (OCR), and others) may be used to perform automated or semi-automated transactions such as contributions, distributions, and others. Using parameters (i.e., rules) specified by tax payers (i.e., consumers, tax advantaged account holders) and federal, local, and state regulations and statutes, the described techniques may be implemented to allow users (i.e., tax payers, consumers, tax advantaged account holders, and others) to input transaction requests and associated data to identify accounts, determine how to withdraw funds, reconcile transactions with regulatory disclosure and reporting requirements, perform administrative functions (e.g., checking account balances, transferring funds, executing stock trades (i.e., generate issue, buy, short, margin directions for securities and other types of traded instruments), and others. Accessibility to tax advantaged account funds without onerous delays due to regulatory compliance and administrative processing delays may be realized using the described techniques.

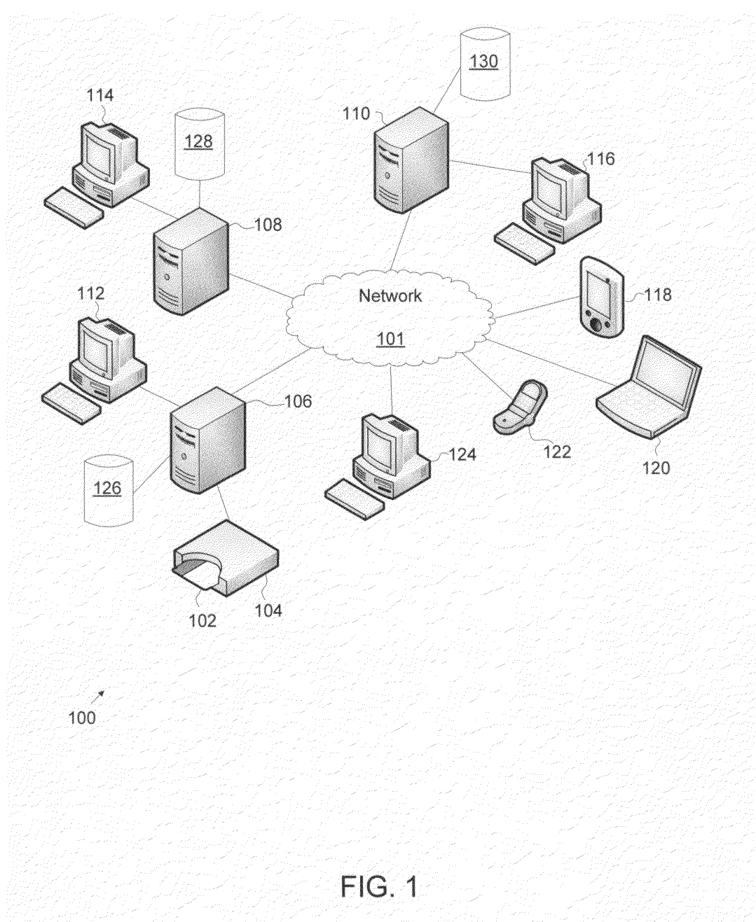

FIG. 1 illustrates an exemplary tax advantaged account transaction and reconciliation data network. Here, network 100 includes network 101, card 102, card reader 104, servers 106-110, clients 112-124, and data repositories or databases (“databases”) 126-130. In some examples, network 100 may be used to perform transactions involving tax advantaged accounts (e.g., individual retirement accounts (IRAs), retirement plans under §401k of the Internal Revenue Code (401k), health savings accounts (HSAs), medical savings accounts (MSAs), educational savings accounts (ESAs), and any other type of account that provides tax advantages such as deferred tax payments or exempt tax paying status). Tax advantaged accounts may be used by inserting a smart card, magnetically-encoded, or other type of card storing data issued by a bank, credit agency, credit union, or other financial services vendor (“vendor”) such as card 102 into any type of device, apparatus, or machine installed with card reader 104 (e.g., an automated teller machine (ATM)). When inserted and read by card reader 104, card 102 may be used to provide account, account holder, identification, authentication, and other information used to access a tax advantaged account.

In some examples, Trustees and custodians (collectively “Trustee”) of tax advantaged accounts may be banks, trust companies, or other financial institutions that maintain custody and administer tax advantaged accounts. For example, a Trustee (not shown) may manage contributions, distributions, or reporting requirements for tax advantaged accounts under its supervision. As another example, a Trustee may also authorize and enable transaction requests (i.e., requests for distributions, contributions, account balances, reports, RMD calculation, or any other type of request entered using card 102 and card reader 104), such as liquidating assets (e.g., stocks, bonds, commodities, certificates of deposit (i.e., CDs), short-term investments, and others) held in a 401k account, or individual retirement account, in order to fund a request for a distribution. A Trustee may, in some examples, use servers 108-110) to provide data networking and communication abilities to transfer financial data associated with a transaction request. Reconciliation (e.g., recording, reporting, and other Trustee-assigned accounting or reporting of transactions affecting tax advantaged accounts) may also be performed using the techniques described herein. Further, administration and management of system 100 may be performed using topologies similar or different to those described.

In some examples, Trustees, vendors, card issuers, and other financial institutions may administer various aspects of system 100 using servers 108-110. For example, system administration of a vendor or bank's network may be implemented and managed using server 108 and client 114, respectively. Data associated with account managed by server 108 may be stored in repository 128. Likewise, a Trustee may use server 110, client 116, and repository 130 to implement another sub-system or data network to system 100. In some examples, account data for accounts under administration by a Trustee may be stored in and retrieved from repository 130. Further, card issuers (i.e., financial institutions that issue financial credit to consumers (i.e., tax payers), which may be spent using card 102) may also implement a data network on system 100 using one, more, or fewer of servers 106-110, clients 112-124, and repositories 126-130.

In some examples, repositories 126-130 may be implemented using more, fewer, or different (e.g., remote databases, local memories or cache, storage area networks (SANs), redundant arrays of independent disks (RAIDs), disk arrays, and others) types of storage facilities apart from those shown. Likewise, servers 106-108 and clients 112-124 may be implemented using any type of wired, wireless, remote, local, desktop, notebook, mobile, or other processor-based device, system, or apparatus, which may be hardware, software, or a combination thereof. System administrators and other users supporting vendors, Trustees, card issuers, and other institutions using system 100 may use clients 112-116 to access, retrieve, store, or perform other data operations on data stored in repositories 106-110.

In some examples, when card 102 is inserted at card reader 104, data is read and sent to a Trustee, for example, using server 108. Server 108 may be used to access repository 128 to determine if card 102 indicates a tax advantaged account under management. If the data indicates a tax advantaged account under management and associated with data stored in, for example, repository 128, then authentication of card 102 may be performed, along with determining whether the transaction request is permissible. In other words, server 108 may be used to determine whether a transaction request indicates a premature or normal distribution, an excess contribution, a request for an account balance, a taxable event, a non-taxable event, and others. Further, processes implemented on server 108 may be modified, supplemented, deleted, or otherwise managed using client 114 as, for example, system administration log on.

Here, a vendor (i.e., credit union, credit agency, or other financial institution) or bank implements card reader 104 using sever 106, client 112, and repository 126. When card 102 is inserted into card reader 104, server 106 transmits data read from card 102 via network 101 to a Trustee (i.e., servers 108 or 110), which evaluates the data and any transaction request associated with card 102. If a transaction is performed, server 108 may also notify a card issuer associated with card 102, a government agency (e.g., Internal Revenue Service (IRS), Securities and Exchange Commission (SEC), Department of Social Services, Department of Homeland Security, or other federal, state, or local governmental or pseudo-governmental agencies requiring notification of transaction activity associated with a tax-advantaged account) (not shown). In other examples, more, fewer, or different entities, institutions, or individuals may also use system 100 to perform transactions involving tax advantaged accounts. Further, system 100 and the above-described elements may be varied in design, function, and implementation and are not limited to the examples shown and described.

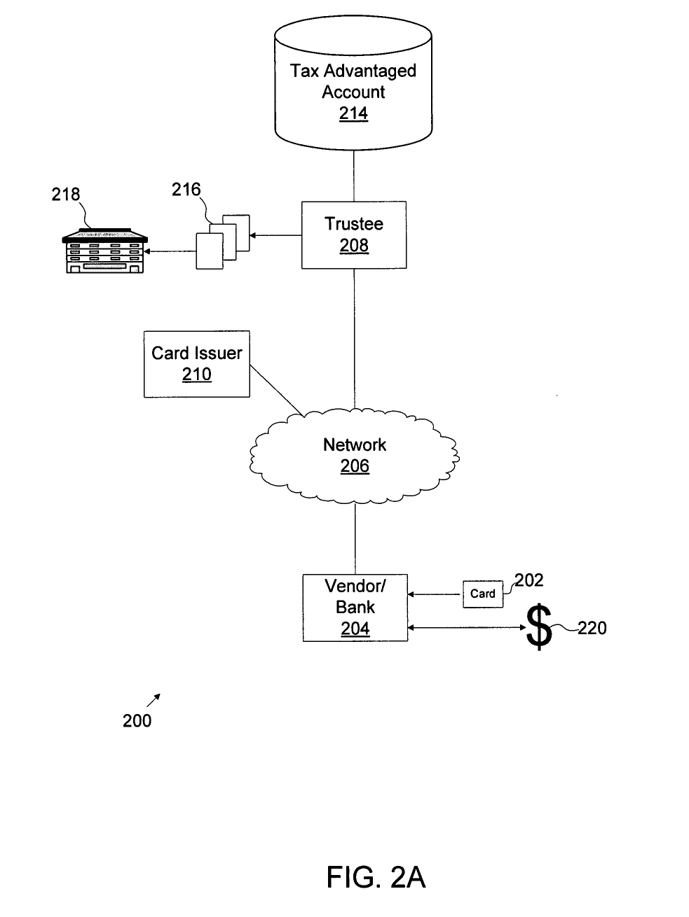

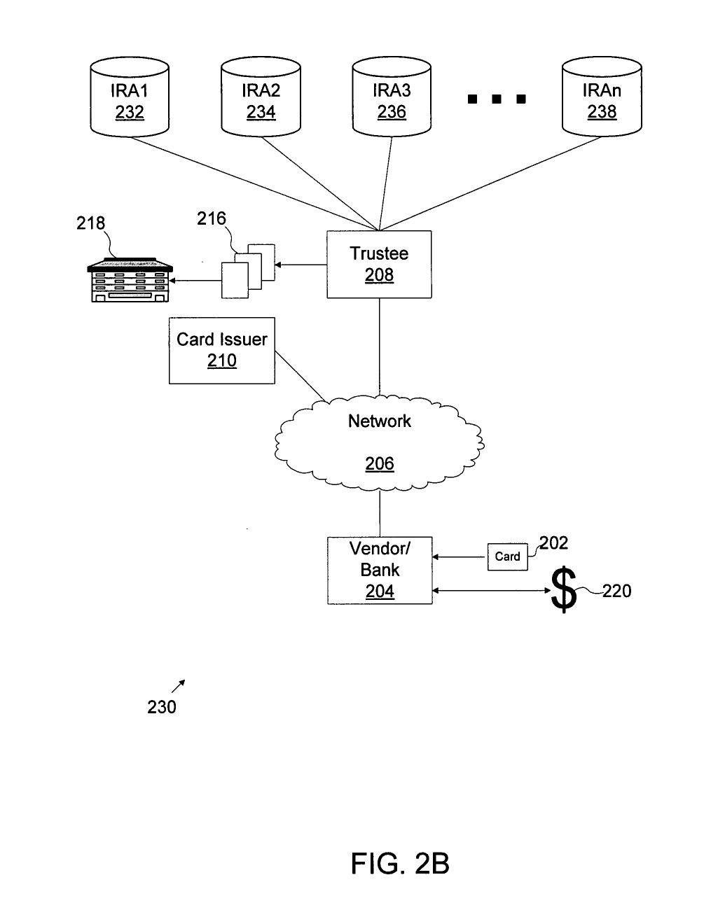

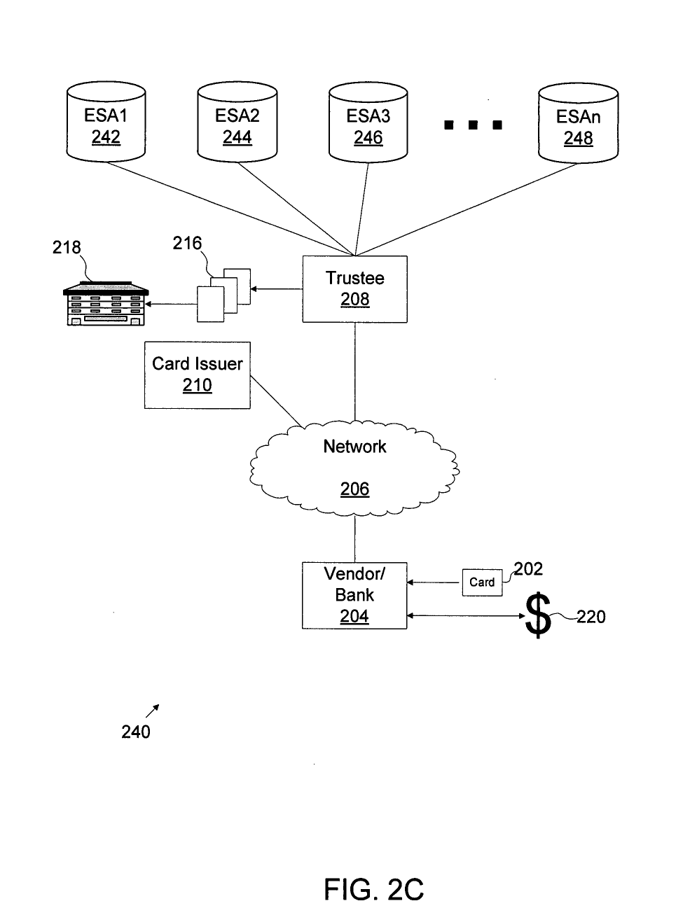

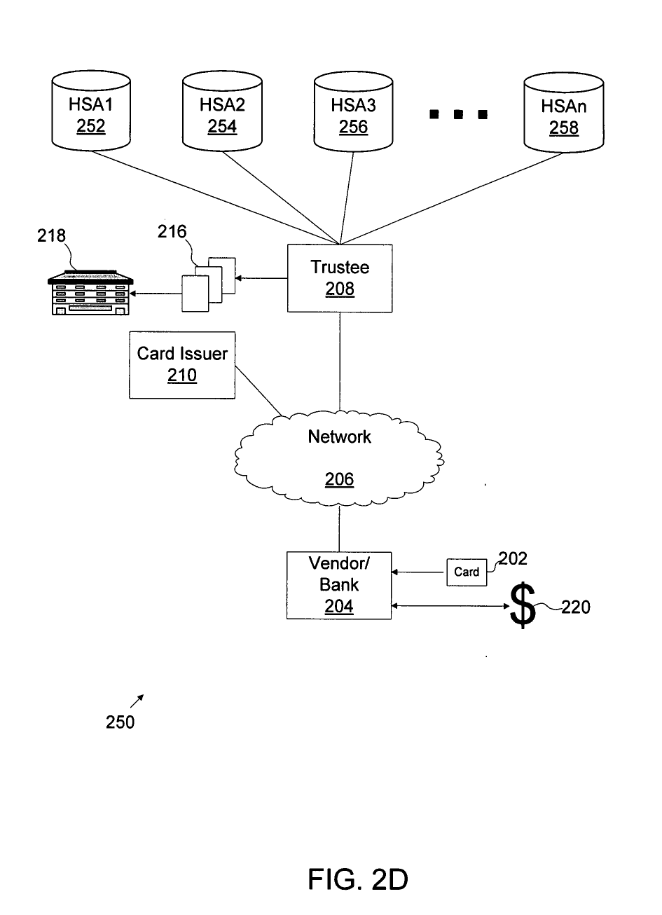

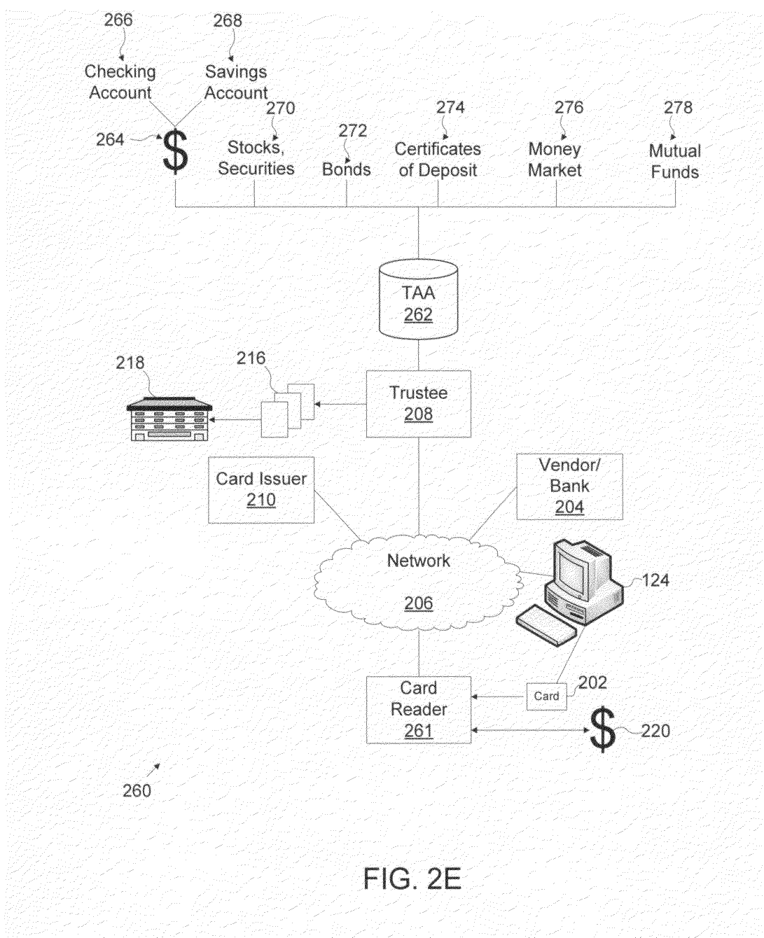

FIG. 2A illustrates an exemplary tax advantaged account transaction and reconciliation system. Here, system 200 includes card 202, vendor/bank 204, network 206, Trustee (i.e., Trustee or custodian) 208, card issuer 210, tax advantaged account data 214, reports 216, and government agency 218. In some examples, card 202 may be inserted into a card reader (e.g., card reader 104, (FIG. 1)) and used to retrieve funds (i.e., cash in any currency) 220 from vendor/bank 204. When inserted, card 202 may be read to provide data that is used identify, authenticate, and perform a transaction associated with a tax advantaged account associated with card 202. In some examples, a tax advantaged account may be an IRA, HSA, ESA, IRC §401k tax-deferred retirement plan, or others. Once authenticated using various types of techniques, card 202 may be used to submit a transaction request via an automated teller machine (ATM) provided and operated by vendor/bank 204. Data read from card 202 and submitted at a machine operated by vendor/bank 204 may be transmitted across network 206 to Trustee 208. When a transaction request is received by Trustee 208, identification, authentication, and performance, if permitted, of a transaction indicated by the transaction request may be performed, using data stored, retrieved, and accessed from tax advantaged account repository 214. Further, upon performance of a transaction, Trustee 208 may generate one or more reports 216 that are sent to agency 218, which may be a third-party, governmental, or pseudo-governmental agency such as a federal, state, or local tax agency or other regulatory authority.

In some examples, when card 202 is read, data may be transferred over network 206 to Trustee 208 and card issuer 210. Data may include a request to perform a transaction associated with tax advantaged account 214 (e.g., distribution, contribution, or other). A request to perform a transaction associated with a tax advantaged account may also be referred to as a transaction request. Transaction requests and other data may be transferred over network 206. In some examples, network 206 may be implemented using one or more data network topologies and equipment, including routers, switches, branches, exchanges, servers, and the like. The type, topology, hardware, and software used to implement network 206 may be varied and is not limited to the examples provided.

Here, card 202 may be provided by card issuer 210, which performs credit and background checks, financial analysis, and other functions associated with providing card 202. Card issuer 210 may also receive data associated with a transaction request when card 202 is read at, for example, an ATM provided by vendor/bank 204. In some examples, if a transaction request is performed successfully (i.e., card 202 is authenticated, the transaction request is performed, reports 216 are generated, and Trustee 208 confirms that sufficient assets exist in the indicated tax advantaged account, but are not liquid (i.e., immediately available as cash 220)), cash 220 may be dispensed (i.e., debited) from, for example, the tax advantaged account. In other examples, a loan may be generated as a result of a transaction request entered with card 202, if assets (i.e., cash 202) are being borrowed from a 401k or other substantially similar tax advantaged retirement plan account. If card 202 is read and a transaction request is sent requesting a distribution, Trustee 208 may authorize vendor/bank 204 to issue cash 220, which may be reconciled as a loan to the consumer using card 202, if assets held in a 401k plan are available for liquidation. In other words, if a tax advantaged account associated with card 202 does not have sufficient cash, money market funds, or other liquid (i.e., short-term) assets, then cash 202 may be distributed as a loan to the consumer and Trustee 208 may retrieve funds from the tax advantaged account by selling, redeeming, or otherwise liquidating assets in the amount of the loan. If the amount of liquidated assets exceeds the amount of the loan (i.e., cash 220), then excess funds may be placed in a checking, savings, money market, or other type of account associated with the tax advantaged account. For example, Trustee 208 may provide a sell direction regarding stocks (i.e., securities, shares) held in a tax advantaged account (e.g., a 401k retirement account), which may permitted by a user or owner of the account when establishing an agreement to receive card 202, open a tax advantaged account such as a 401k retirement plan account, and others. Cash and yields gained from the sale of the stocks may be used to provide a distribution in the form of cash 220. In other examples, card 202 may be used to provide a contribution to a tax advantaged account.

As an example, card 202 may be entered and read at an ATM provided by vendor/bank 204. Using data read from card 202, a tax advantaged account may be identified by Trustee 208, which may be configured to retrieve data associated with the tax advantaged account from tax advantaged account database 214. Once identified and authenticated, cash 220 may be contributed using, for example, an ATM provided by vendor/bank 204. As described in greater detail below, transaction requests for contributing funds to a tax advantaged account may be authorized by Trustee 208 after a determination is made that the type and amount of contribution is permitted. For example, the amount of a contribution may be checked against an annual limit of contributions authorized for a given type of tax advantaged account. If the limit is exceeded, the contribution may be rejected. Alternatively, if the limit is not reached and the contribution is permissible given existing contribution limits or other parameters, then the contribution (i.e., cash 220) may be submitted. In other examples, system 200 and the above-described elements may be varied and is not limited to the descriptions provided.

FIG. 2B illustrates an alternative exemplary tax advantaged account transaction and reconciliation system. Here, system 230 includes card 202, vendor/bank 204, network 206, Trustee 208, card issuer 210, reports 216, agency 218, and IRAs 232-238. In some examples, more, fewer, or different types of accounts other than IRAs 232-238 may be implemented and system 230 is not limited to the types and numbers shown. As an example, card 202 may be read at an ATM or other card reading-device provided by vendor/bank 204 in order to receive a distribution, make a contribution, or perform another transaction associated with one or more of IRAs 232-238. In some examples, the number and type of IRAs 232-238 may be varied and are not limited to those shown. Further, Trustee 208 may access IRAs 232-238 to provide a distribution or make a contribution in response to a transaction request associated with card 202. In other examples, one or more tax advantaged accounts (e.g., IRAs 232-238) may be associated with a given card (e.g., card 202) and, when a transaction request is received, a user may select a tax advantaged account for a distribution, contribution, or other transaction. Alternatively, a user may specify parameters (e.g., rules) that determine how a distribution, contribution, or other transaction is made. For example, if IRA 232 includes cash, stocks, securities, certificates of deposit, and other short-term liquid assets, a user may specify one or more parameters that govern a transaction when a request is received. If a transaction request to withdraw cash (i.e., take a distribution) is received, one or more parameters may be specified to determine the source of the requested funds. As an example, a parameter may be specified that indicates funds are to be withdrawn from cash, then certificates of deposit, and then low interest-bearing instruments thereafter. As another example, a user may also specify a parameter that prevents a distribution from being performed if cash associated with a tax advantaged account (e.g., IRAs 232-238) is not sufficient to cover the requested distribution amount. Still another example, a user may specify that a distribution is rejected if the amount requested does not meet a required minimum distribution (RMD). Yet another example, if a transaction request for a contribution is received, a user may specify the order in which funds are contributed to one or more of IRAs 232-238. A user may also specify how a contribution is made to a given IRA. For example, if a user submits a transaction request to contribute funds to one or more of IRAs 232-238, a user may specify that funds are deposited into cash, checking, savings, or a money market account. In other examples, different types of transaction requests may be performed using different parameters part from those described.

FIG. 2C illustrates another alternative exemplary tax advantaged account transaction and reconciliation system. Here, system 240 includes card 202, vendor/bank 204, network 206, Trustee 208, card issuer 210, reports 216, agency 218, and ESAs 242-248. In some examples, ESAs 242-248 may be used to save money for child educational costs. Using card 202, funds may be distributed or contributed to ESAs 242-248. Card 202 may be read at an ATM (i.e., a card reader) provided by vendor/bank 204 and, once authenticated and the associated ESAs have been identified, a user may specify a transaction request to distribute, contribute, check a balance, or perform other transactions. Here, when a transaction request is made (i.e., card 202 is read at vendor/bank 204), funds may be withdrawn (i.e., distributed) or deposited (i.e., contributed) to ESAs 242-248. For example, a user may want to receive a distribution from ESA 244 for use in paying a child's undergraduate educational costs. Using card 202 at vendor/bank 204, a user submits a transaction request via network 206 to Trustee 208 for receiving a distribution from ESA 246. In some examples, parameters may be specified by a user to determine how funds are withdrawn. In other examples, parameters may be specific by a user to determine how funds are contributed to ESAs 242-248. System 240 and the above-described elements may be varied in design, function, and implementation and are not limited to the examples provided.

FIG. 2D illustrates a further exemplary tax advantaged account transaction and reconciliation system. Here, system 250 includes card 202, vendor/bank 204, network 206, Trustee 208, card issuer 210, reports 216, agency 218, and HSAs 252-258. In some examples, card 202 may be used to perform transactions associated with tax advantaged accounts such as receiving cash 220 as a distribution from a HSA or MSA for medical and health care-related expenses. In some examples, a user may receive a distribution from one or more of HSAs 252-258 using card 202. In other examples, a user may contribute to one or more of HSAs 252-258 using card 202. When a transaction is performed, Trustee 208 generates reports 216, which may be sent to agency 218. In some examples, reports 216 may include forms such as IRS Forms 5498, 1099R, and others used to report a contribution, fair market value, distributions, or other transaction. In some examples, if a transaction request is submitted to withdraw funds from one or more of HSAs 252-258, Trustee 208 may direct vendor/bank 204 to distribute the funds if sufficient funds are present. Further, Trustee 208 may determine whether the transaction request indicates a taxable (i.e., taxes are to be withheld) or non-taxable (i.e., exempt from tax withholdings) event. If a user is able to demonstrate a distribution is qualified expense (i.e., produces receipts to Trustee 208 that the expenses for which the distribution was used was a qualified health or medical expense), then the transaction may be identified as non-taxable. However, if a distribution is taken for a non-qualified expense, then the transaction is taxable. Alternatively, if contributions made at an ATM accessed using card 202 occurs, Trustee 208 may track and report these as excess contributions. In some examples, card 202 may also be used in lieu of a credit card (i.e., as a debit card as described above) when paying for qualified expenses. When provided to a card reader for use at, for example, a point of purchase or sale (“POS”), card 202 may access an electronic data network (e.g., network 206) to pay for purchases. Card 202 may used to receive distributions (i.e., cash 220) or, when used at a point of sale purchase or as a credit card, authorization may be provided by card issuer 210. When card 202 is used as a credit card, Trustee 208 reports the payment as a distribution to, for example, the Internal Revenue Service. The determination of whether to permit a distribution to occur when card 202 is used at a credit card POS terminal or other credit-card reading device or system may be made based on whether cash or other liquid assets may be distributed from the indicated tax advantaged account. In some examples, if card 202 is used as a debit card, then Trustee 208 may report corresponding payments (i.e., distributions) as taxable until the user provides receipts to Trustee 208 showing that the purchases made were qualified expenses. In other examples, card 202 may be used differently. Further, system 250 and the above-described elements may be varied in design, function, and implementation and are not limited to the examples provided.

FIG. 2E illustrates yet another alternative exemplary tax advantaged account transaction and reconciliation system. Here, system 260 includes card 202, card reader 261, vendor/bank 204, network 206, Trustee 208, card issuer 210, reports 216, agency 218, cash 220, tax advantaged account (TAA) 262, cash 264 (which may also be apportioned in various types of accounts (e.g., checking account 266, savings account 268, and others), stocks/securities 270, bonds 272, certificates of deposit (CDs) 274, money market account 274, and mutual funds 278. As described above, various types of tax advantaged accounts may be accessed using card 202 at card reader 261, which may be installed as part of an ATM, POS or EFTPOS (i.e., electronic funds transfer point-of-sale) system, or provided at client 280 for electronic commerce-based purchases. In other words, when used at an ATM, distributions or contributions may be made in the form of cash 220. When used as a credit card, card 202 may be read at card reader 261. Still further, when used to make purchases on the Internet (i.e., “online”), card 202 may also be used to provide an electronic number, expiration date, and card verification number (i.e., card identification number, and others). Card 202 may be linked to an electronic commercial or consumer credit financial institution or system such as card issuer 210, which may provide electronic authorization from Trustee 208 for card 202 to be used as a credit or debit card (i.e., if sufficient assets are available in the linked tax advantaged account). Further, once approved, card 202 may receive distributions authorized and managed by Trustee 208 from various types of accounts and funding sources. For example, cash 264 may be distributed from TAA 262, when requested using card 202. Parameters may be specified by a user to withdraw cash 264 from checking account 266 before withdrawing from savings account 268. Alternatively, a user may also specify that distributions may be taken from other sources such as stocks/securities 270, bonds 272, certificates of deposit (CDs) 274, money market account 274, mutual funds 278, and others not shown here. Requests for distributions may be received either at the time card 202 is used (i.e., at an ATM, POS, EFTPOS, online, telephone purchase) or beforehand when, for example, a user completes authorization forms with Trustee 208 to open an account and receive card 202.

Further, users may specify or “opt in” or “opt out” of individual programs associated with a given tax advantaged account, such as loan programs offered by, for example, vendor/bank 204, Trustee 208, or others. For example, card 202 may provide a user with access to receiving funds in the form of a distribution or a loan provided by Trustee 208, which may also be a bank, trust company, or other financial institution. However, if a user declines, a loan option may be removed from a user interface that is presented on an ATM when card 202 is inserted and read. In other examples, card 202 may be used differently and is not limited to the examples provided. Still further, system 260 and the above-described elements may be varied in design, function, and implementation and are not limited to the examples shown.

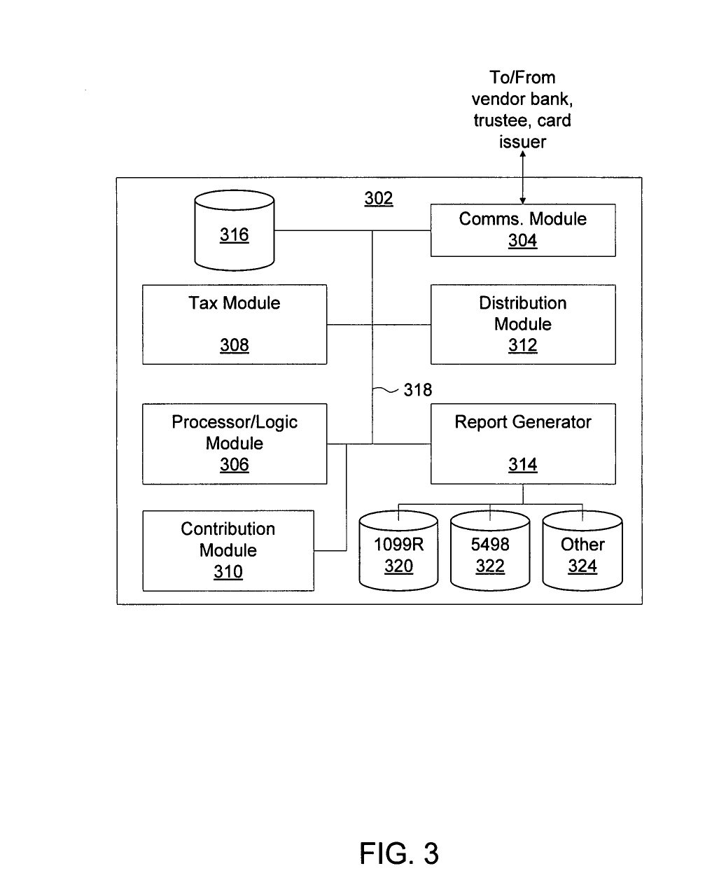

FIG. 3 illustrates an exemplary tax advantaged account transaction and reconciliation application architecture. Here, application 302 includes communications module 304, processor/logic module 306, tax module 308, contribution module 310, report generator 314, repository 316, data bus 318, forms databases 320-324. The techniques described herein may be implemented as hardware, software, circuitry, or a combination thereof. In some examples, application 302 may be used to implement systems such as those shown in FIGS. 2A-2E. As an example, when data (e.g., transaction request) is received from a card (e.g., card 202 (FIGS. 2A-2E)), communications module 304 transfers the data to processor logic module 306, which determines the type of request being made, authorization, authentication, identification, and other functions. Using tax module 308, processor/logic module 306 may determine whether the transaction request indicates a taxable event (e.g., distribution). Distribution module 312 may be used to process a transaction request for a distribution, determining how the distribution is made, whether the funds are available to fund the distribution, whether the distribution is permitted, and other determinations. Contribution module 310 may be used to determine whether a contribution requested using card 202 is permitted, whether the contribution is excess (i.e., in excess of the annual maximum amount permitted), and how the contribution may be made (e.g., where should cash 220 (FIGS. 2A-2E) be placed). Tax module 308 may be used to determine how much tax a given transaction should be assessed, transfer those taxes to relevant agencies (e.g., agency 218, IRS, or other state and local taxation agencies or institutions), and other related functions beyond those described here. Further, when a transaction request is completed, report generator 314 may be directed by processor/logic module 306 to determine what reports, if any, to generate and send to agencies or other institutions. For example, if a contribution is made report generator 314 may generate a Form 5498 to send to the IRS indicating a contribution was made to a tax advantaged account, such as those shown and described above. As another example, if a distribution is taken, a Form 1099R may be generated by report generator 314 and transmitted by communications module 304 to agencies or institutions such as the IRS. In some examples, distributions may include cash or credit distributed using card 202. In other examples, application 302 may perform other functions beyond those described above.

In some examples, application 302 may be used, for example, by Trustee 208 (FIGS. 2A-2E) installed on a server managed, hosted, or otherwise accessed by system administrators of Trustee 208. Application 208 may also be implemented on systems used by other institutions, entities, organizations, agencies, or others. Further, application 302 may be implemented on a single or multiple processor server or other processing or computing device. Alternatively, application 302 may also be implemented on multiple servers configured in a distributed topology using, for example, data communication protocols such as IEEE WSDL (i.e., web services distributed language) or other communication protocols. In other words, application 302 and the above-described elements may be implemented at different locations, separate data networks, or on a distributed network (e.g., wide area network (WAN), local area network (LAN), municipal area network (MAN), wireless local area network (WLAN), and others). Still further, application 302 and the above-described elements may be varied in function, design, layout, implementation, and topologies and are not limited to the examples shown and described.

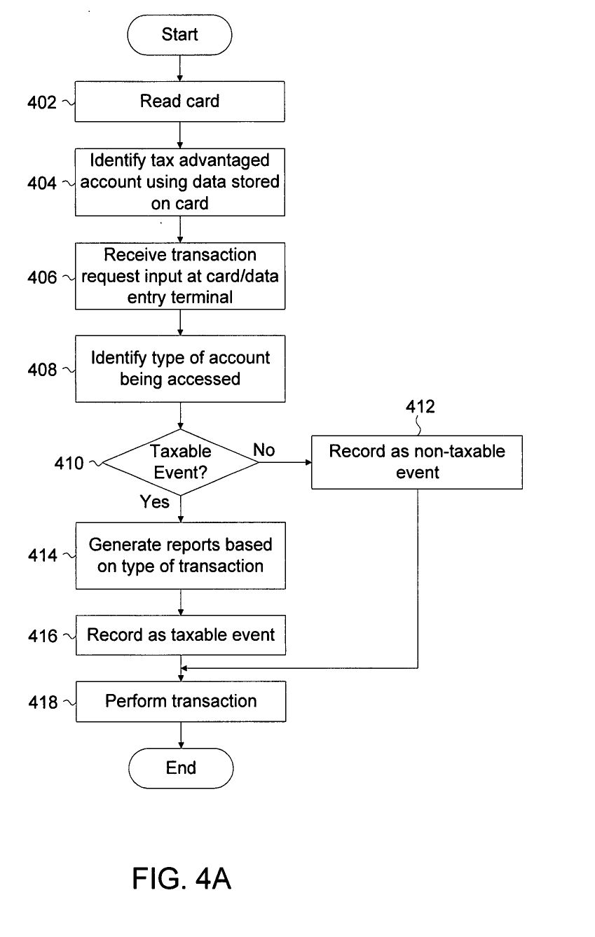

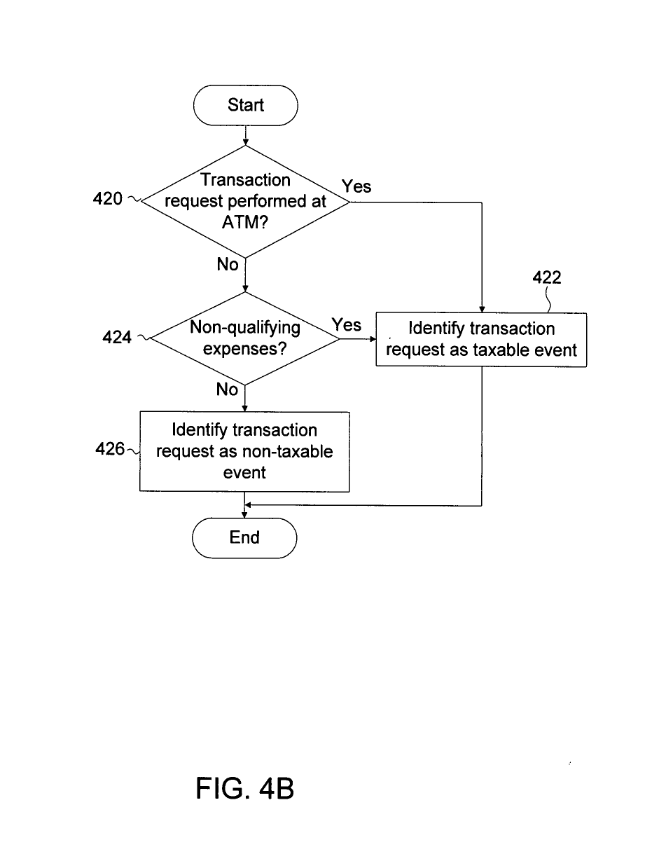

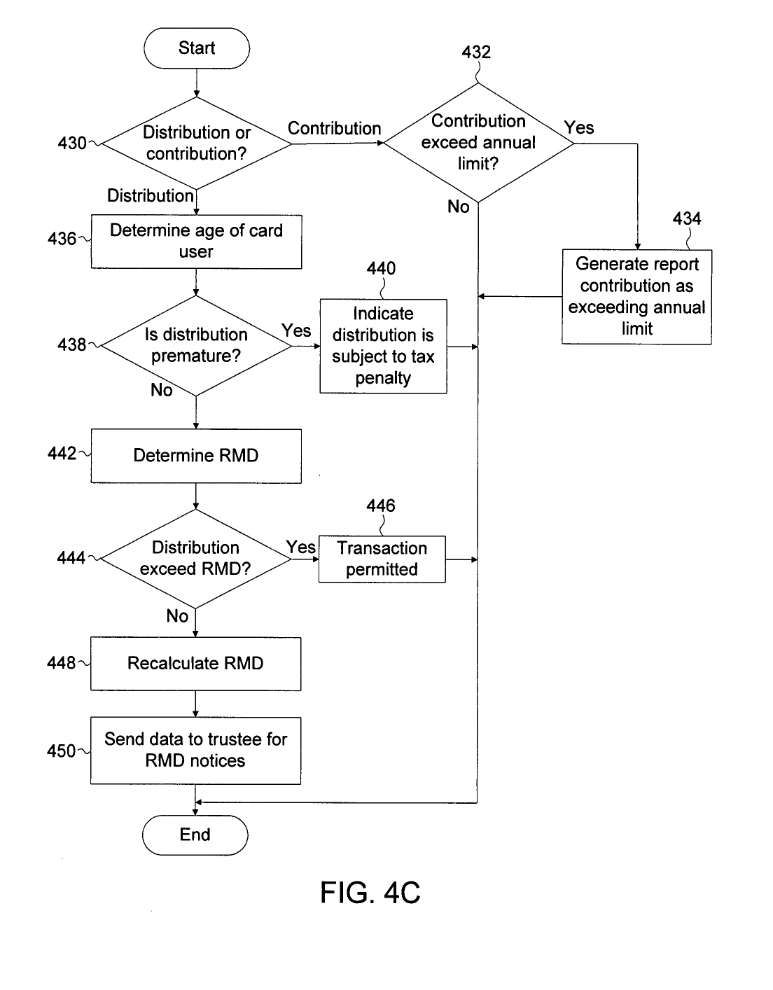

FIG. 4A illustrates an exemplary tax advantaged account transaction and reconciliation process. Here, a card (e.g., card 202 (FIGS. 2A-2E)) is read (402). Information read from the card is used to identify one or more tax advantaged accounts (404). A transaction request is received as an input at the card or card data entry location (406). In some examples, a card data entry location may be an ATM, a POS card reader, a EFTPOS card reader, a credit card reader, and others. An identification is made as to the type of account being accessed (408). Types of accounts may include, but are not limited to HSAs, ESAs, IRAs, 401k plans, and others. A determination is made as to whether the transaction request indicates a taxable event (410). If the transaction request does not indicate a taxable event, then the transaction is identified as a non-taxable event (e.g., checking account balances, retrieving information only, or other similar transactions that do not cause contributions, distributions, or other effects to a tax advantaged account to occur) (412). If the transaction request indicates a taxable event (e.g., distribution, and others), then reports are generated based on the type of transaction (414), the event is recorded as a taxable event (416), and the transaction is then performed (418). Once performed, the process ends. The above-described process is an example of how tax advantaged account transactions and reconciliation may be implemented. Further, the above-described process may be varied and is not limited to the examples shown and described. In other examples, more, fewer, or different processes or sub-processes other than those shown and described may be practiced.

FIG. 4B illustrates an exemplary tax advantaged account transaction and reconciliation sub-process. Here, a sub-process for determining whether an event is taxable is shown and described in further detail apart from that provided above in connection with sub-process 410 (FIG. 4A). In some examples, a determination is made as to whether a transaction request is received at, for example, an ATM (420). If a transaction request was made at an ATM, the transaction is identified as a taxable event for later recordation (422). Similarly, if a transaction request is received from a client in data communication with Trustee 208 (FIGS. 2A-2E), identification as a taxable event may also occur. Still further, when a transaction request is received from a source where an unverified purchase, cost, or expense is being incurred against a tax advantaged account, then identification of the transaction request and ensuing transaction may be identified as a non-qualified expense and taxable event. Alternatively, if a transaction is not performed at an ATM, then a determination is made as to whether the transaction request indicates a non-qualifying expense (i.e., expense, cost, purchase, or other request to use funds from a tax advantaged account that is not exempt from either taxation or tax penalties for being prematurely withdrawn (e.g., taking a distribution before the minimum allowed age, borrowing or receiving a loan from proceeds deposited into a tax advantaged account, and the like), and others) (424). If a non-qualifying expense is indicated by the transaction request, then identification as a taxable event occurs (422). However, if the transaction request does not indicate non-qualifying expenses are being incurred, then the transaction request and its ensuing transaction are identified as a non-taxable event (426). In other examples, more, fewer, or different processes or sub-processes other than those shown and described may be practiced.

FIG. 4C illustrates another exemplary tax advantaged account transaction and reconciliation sub-process. Here, sub-process 408 (FIG. 4A) is shown and described in greater detail, as an exemplary implementation. In some examples a determination is made as to whether a distribution or a contribution is being made (430). If a contribution is being made, another determination is made as to whether the contribution to a tax advantaged account indicated in a transaction request exceeds an annual limit (432). If the transaction request indicates a contribution that exceeds the annual limit (i.e., as defined by statute), then a report is generated that identifies the contribution as an excess contribution, which triggers a taxable event that is reportable on a form 5329, for example, for excess contributions (434). If a distribution is indicated by a transaction request, then the age of the card user is determined (436). Based on the identified, calculated, or otherwise determined age of the user, a determination is made as to whether the distribution is premature (438).

In some examples, if a distribution is premature (i.e., the card user requesting the distribution is below the statutorily-defined minimum age above which a tax penalty does not apply), then the transaction request for the distribution is indicated (i.e., by distribution module 312 (FIG. 3)) as being subject to a tax penalty (440). If a determination is made that the transaction request for a distribution is not premature, then the required minimum distribution (RMD) is determined (442). Subsequently, a determination is made as to whether the distribution indicated by the transaction request exceeds the RMD (444). If the distribution exceeds the RMD, then the transaction is permitted and an indication is provided that the distribution may be performed (446). However, if the distribution does not exceed the RMD, then the RMD is recalculated (448). In other examples, if the distribution indicated by a transaction request does exceed the RMD, the transaction may be rejected, if there are not sufficient funds or assets that may be liquidated by, for example, Trustee 208. Alternatively, if sufficient funds or assets are held in the account and may be liquidated to perform a transaction request for a distribution that does meet the RMD, then the transaction may not be rejected. Further, if the distribution does not exceed the RMD, then the transaction may be handled differently than shown and described. Data is sent to Trustee 208 (FIGS. 2A-2E) to generate RMD notices to send to the user, tax agencies, or other reporting agencies statutorily required (450). Other examples may be implemented and are not limited to those shown and described.

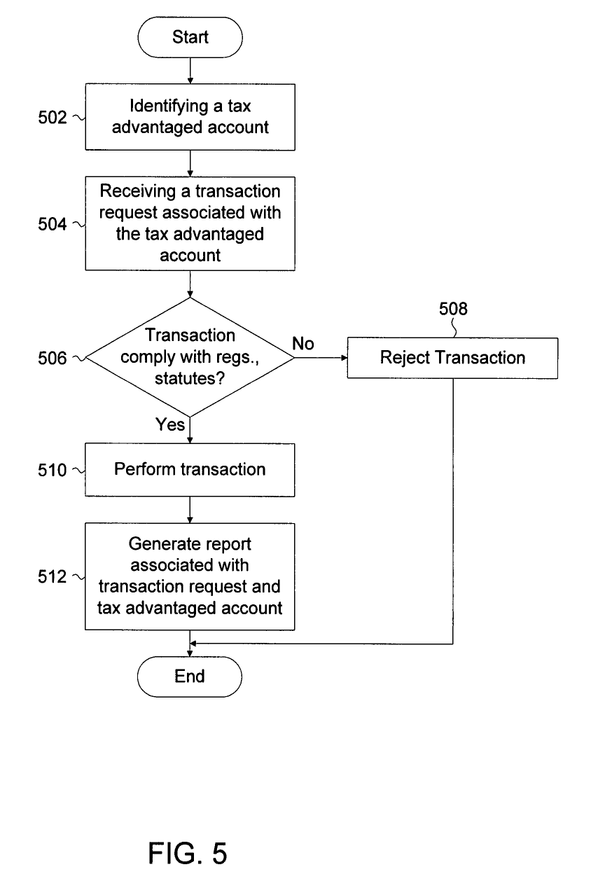

FIG. 5 illustrates an alternative exemplary tax advantaged account transaction and reconciliation process. Here, a tax advantaged account is identified (502). A tax advantaged account may be identified by reading data from card 202 (FIGS. 2A-2E). Data may be read from a card that uses various techniques (e.g., magnetic, semiconductor memory, solid state memory, non-volatile memory, smart card, and other memory technologies) to store data, such as card number, account number, expiration date, user parameters (e.g., identification of a given tax advantaged account for use with distributions, contributions, and the like, preferences specifying a primary, second, tertiary, or other prioritized source of funds to be used for distributions, and others), and others. A transaction request associated with the identified tax advantaged account is received (504). A determination is made as to whether a transaction indicated by the transaction request complies with regulations, statutes, and the like (506). If the transaction indicated by the transaction request does not comply, then the transaction is rejected (508). If the transaction request complies, then the transaction is performed (510). After performing the transaction, reports are generated by Trustee 208 (FIGS. 2A-2E) and sent indicating that the transaction was performed involving a tax advantaged account and that specific rules governing the type of tax advantaged account were followed (512). Reports may also include, in some examples, notifications via U.S. mail, overnight mail, electronic mail (e-mail), and automated or manual voicemails sent to the user that the transaction was performed. For example, if the tax advantaged account identified using card 202 is an ESA, then a distribution of cash 220 (FIGS. 2A-2E) at an ATM may occur, but is treated as a taxable event until the card user, for example, provides receipts that show the distribution was made for qualifying expenses such as child educational costs, tuition, books, and the like. As another example, if the tax advantaged account is an IRA, a distribution of cash may occur, but a tax penalty may be assessed if the card user (i.e., the person using card 202) is below the minimum allowable age for taking a distribution without penalty. As yet another example, if the tax advantaged account is an HSA or MSA, then a distribution may occur in the form of a qualified expense if, the vendor operating the POS is registered as a qualified expense provider (e.g., hospital, medical clinic, pharmacy, and the like). In other examples, the above-described process and sub-processes may be varied and are not limited to the examples shown and described.

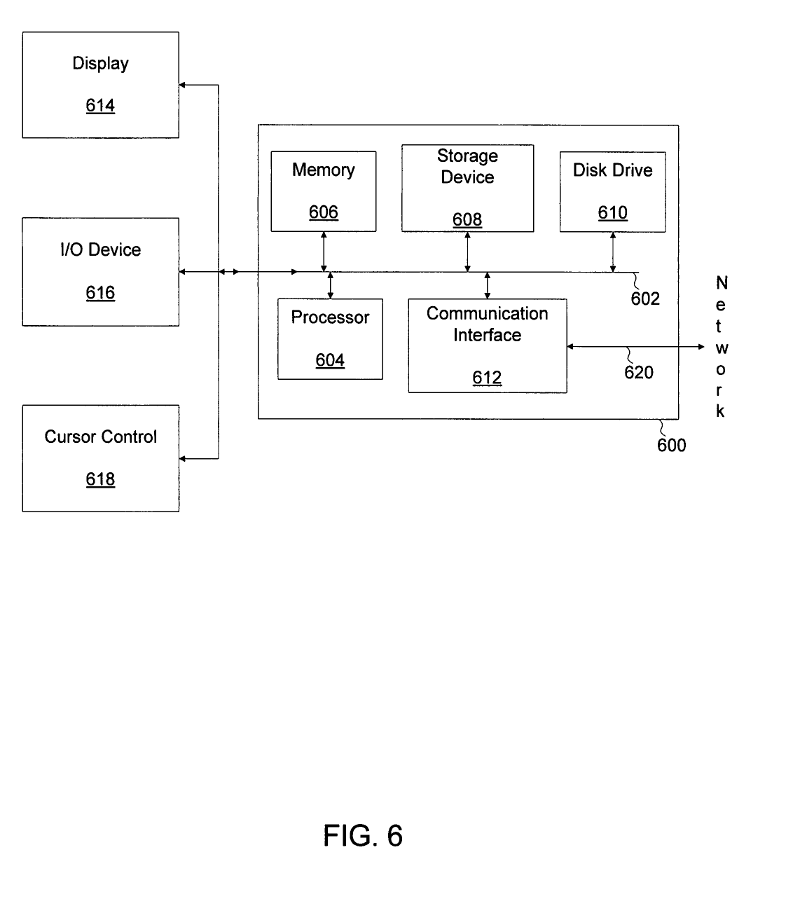

FIG. 6 illustrates an exemplary computer system suitable for tax advantaged account transaction and reconciliation. In some examples, computer system 600 may be used to implement computer programs, applications, methods, processes, or other software to perform the above-described techniques. Computer system 600 includes a bus 602 or other communication mechanism for communicating information, which interconnects subsystems and devices, such as processor 604, system memory 606 (e.g., RAM), storage device 608 (e.g., ROM), disk drive 610 (e.g., magnetic or optical), communication interface 612 (e.g., modem or Ethernet card), display 614 (e.g., CRT or LCD), input device 616 (e.g., keyboard), and cursor control 618 (e.g., mouse or trackball).

According to some examples, computer system 600 performs specific operations by processor 604 executing one or more sequences of one or more instructions stored in system memory 606. Such instructions may be read into system memory 606 from another computer readable medium, such as static storage device 608 or disk drive 610. In some examples, hard-wired circuitry may be used in place of or in combination with software instructions for implementation.

The term “computer readable medium” refers to any medium that participates in providing instructions to processor 604 for execution. Such a medium may take many forms, including but not limited to, non-volatile media, volatile media, and transmission media. Non-volatile media includes, for example, optical or magnetic disks, such as disk drive 610. Volatile media includes dynamic memory, such as system memory 606. Transmission media includes coaxial cables, copper wire, and fiber optics, including wires that comprise bus 602. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some examples, execution of the sequences of instructions may be performed by a single computer system 600. According to some examples, two or more computer systems 600 coupled by communication link 620 (e.g., LAN, PSTN, or wireless network) may perform the sequence of instructions in coordination with one another. Computer system 600 may transmit and receive messages, data, and instructions, including program, i.e., application code, through communication link 620 and communication interface 612. Received program code may be executed by processor 604 as it is received, and/or stored in disk drive 610, or other non-volatile storage for later execution.

The foregoing examples have been described in some detail for purposes of clarity of understanding, but are not limited to the details provided. There are many alternative ways and techniques for implementation. The disclosed examples are illustrative and not restrictive.

What is claimed:

1. A method, comprising:
identifying a tax advantaged account, the tax advantaged account being identified using a card configured to store data;
receiving a transaction request, the transaction request being associated with the tax advantaged account;
determining whether the transaction request indicates a taxable event;
performing a transaction associated with the transaction request and the tax advantaged account; and
generating a report associated with the tax advantaged account, the report indicating that a transaction was performed based on the transaction request.

2. The method of claim 1, further comprising determining whether a contribution limit associated with the tax advantaged account is exceeded.

3. The method of claim 1, further comprising determining whether a contribution limit is reached if the transaction is performed.

4. The method of claim 1, further comprising determining whether the card is being used at an automated teller machine.

5. The method of claim 1, wherein the transaction is the taxable event if the card is used at an automated teller machine.

6. The method of claim 1, wherein the transaction request is the taxable event if the card is used at an automated teller machine.

7. The method of claim 1, wherein the tax advantaged account is an IRA.

8. The method of claim 1, wherein the tax advantaged account is an ESA.

9. The method of claim 1, wherein the tax advantaged account is an HSA.

10. The method of claim 1, wherein the transaction request is sent to a custodian associated with the tax advantaged account.

11. The method of claim 1, wherein the transaction request indicates a distribution from the tax advantaged account.

12. The method of claim 1, wherein the transaction request indicates a contribution to the tax advantaged account.

13. The method of claim 1, wherein the report indicates the transaction was a contribution to the tax advantaged account.

14. The method of claim 1, wherein the report indicates the transaction was a distribution from the tax advantaged account.

15. A method, comprising:
identifying a tax advantaged account, the tax advantaged account being identified using a card configured to store data associated with the tax advantaged account;
receiving a transaction request, the transaction request being associated with the tax advantaged account;
determining whether the transaction request complies with one or more parameters, the one or more parameters being used to determine whether a transaction associated with the transaction request is permitted;
performing a transaction associated with the transaction request and the tax advantaged account if the transaction request complies with the one or more parameters; and
generating a report associated with the tax advantaged account, the report indicating that a transaction was performed based on the transaction request.

16. A system, comprising:
a card configured to electronically access a tax advantaged account;
a memory configured to store data associated with the tax advantaged account; and
a processor configured to identify the tax advantaged account, the tax advantaged account being identified using a card configured to store the data, to receive a transaction request, the transaction request being associated with the tax advantaged account, to determine whether the transaction request indicates a taxable event, to perform a transaction associated with the transaction request and the tax advantaged account, and to generate a report associated with the tax advantaged account, the report indicating that a transaction was performed based on the transaction request.

17. A system, comprising:
a card configured to electronically access a tax advantaged account;
a database configured to store data associated with the tax advantaged account; and
a logic module configured to identify a tax advantaged account, the tax advantaged account being identified using a card configured to store data associated with the tax advantaged account, to receive a transaction request, the transaction request being associated with the tax advantaged account, to determine whether the transaction request complies with one or more parameters, the one or more parameters being used to determine whether a transaction associated with the transaction request is permitted, to perform a transaction associated with the transaction request and the tax advantaged account if the transaction request complies with the one or more parameters, and to generate a report associated with the tax advantaged account, the report indicating that a transaction was performed based on the transaction request.

18. A computer program product embodied in a computer readable medium and comprising computer instructions for:
identifying a tax advantaged account, the tax advantaged account being identified using a card configured to store data;
receiving a transaction request, the transaction request being associated with the tax advantaged account;
determining whether the transaction request indicates a taxable event;
performing a transaction associated with the transaction request and the tax advantaged account; and
generating a report associated with the tax advantaged account, the report indicating that a transaction was performed based on the transaction request.

19. A computer program product embodied in a computer readable medium and comprising computer instructions for:
identifying a tax advantaged account, the tax advantaged account being identified using a card configured to store data associated with the tax advantaged account;
receiving a transaction request, the transaction request being associated with the tax advantaged account;
determining whether the transaction request complies with one or more parameters, the one or more parameters being used to determine whether a transaction associated with the transaction request is permitted;
performing a transaction associated with the transaction request and the tax advantaged account if the transaction request complies with the one or more parameters; and
generating a report associated with the tax advantaged account, the report indicating that a transaction was performed based on the transaction request.
